(19) United States
(12) Patent Application Publication
(10) Pub. No.: US 2024/0034326 A1
(43) Pub. Date: Feb. 1, 2024

(54) VEHICLE AND CONTROL METHOD THEREOF

(71) Applicants: HYUNDAI MOTOR COMPANY, Seoul (KR); KIA CORPORATION, Seoul (KR)

(72) Inventor: Sangheon Lee, Gwacheon-si (KR)

(73) Assignees: HYUNDAI MOTOR COMPANY, Seoul (KR); KIA CORPORATION, Seoul (KR)

(21) Appl. No.: 18/199,209

(22) Filed: May 18, 2023

(30) Foreign Application Priority Data
Jul. 28, 2022 (KR) 10-2022-0093595

(51) Int. Cl. B60W 40/06; B60R 1/27

(52) U.S. Cl. CPC B60W 40/06; B60R 1/27; B60W 2552/15; B60R 2300/802

(57) ABSTRACT

A vehicle and a control method thereof are capable of automatically displaying a surround view image depending on a condition of a road surface. The vehicle includes at least one sensor, a display, a surround view monitor system, and a controller. The surround view monitor system is configured to obtain a surround view image. The controller is configured to estimate a gradient of the road surface based on a sensor value received from the at least one sensor and to control the display to display at least a part of the surround view image based on a preset condition related to the gradient of the road surface being satisfied.

### CROSS-REFERENCE TO RELATED APPLICATION

This application is based on and claims the benefit of and priority under 35 U.S.C. § 119 to Korean Patent Application No. 10-2022-0093595, filed on Jul. 28, 2022 in the Korean Intellectual Property Office, the entire contents of which are incorporated herein by reference.

### BACKGROUND

### 1. Technical Field

The present disclosure relates to a vehicle capable of displaying a surround view image and a control method thereof.

### 2. Description of the Related Art

Vehicles are sometimes equipped with technology for estimating a gradient of a road surface using various sensor signals.

In addition, vehicles are sometimes equipped with technology that provides passengers with an image that is seen as if looking down at a vehicle from the sky using a plurality of cameras (hereinafter, “surround view image”).

However, even when the demand for a surround view image is high, a typical vehicle provides the surround view image only in response to a manual operation of a user and cannot automatically provide the surround view image.

### SUMMARY

An aspect of the present disclosure provides a vehicle capable of automatically displaying a surround view image depending on a gradient of a road surface and a control method thereof.

Additional aspects of the present disclosure are set forth in part in the description which follows and, in part, should be apparent from the following description or may be learned by practice of the present disclosure.

In accordance with an aspect of the present disclosure, a vehicle includes at least one sensor, a display unit, a surround view monitor system, and a controller. The surround view monitor system is configured to obtain a surround view image. The controller is configured to estimate a gradient of a road surface based on a sensor value received from the at least one sensor. The controller is also configured to control the display unit to display at least a part of the surround view image based on a preset condition related to the gradient of the road surface being satisfied.

The controller may be configured to estimate a longitudinal gradient of the road surface in real time. The controller may also be configured to determine that an uphill condition is satisfied based on determining that the longitudinal gradient of the road surface is greater than a first threshold value. The controller may further be configured to determine a maximum value of the longitudinal gradient in response to determining that the uphill condition is satisfied. The controller may additionally be configured to determine that the preset condition is satisfied based on determining that a difference value between the maximum value of the longitudinal gradient and the longitudinal gradient of the road surface estimated in real time is greater than a second threshold.

The controller may be configured to control the display unit to stop outputting the surround view image based on determining that the longitudinal gradient of the road surface estimated in real time has reached a third threshold value less than the first threshold value after the uphill condition is satisfied.

The controller may be configured to estimate a lateral gradient of the road surface in real time and determine that the preset condition is satisfied based on determining that a magnitude of the lateral gradient of the road surface is greater than a first threshold value.

The controller may be configured to control the display unit to stop outputting the surround view image based on determining that the magnitude of the lateral gradient of the road surface estimated in real time has reached a second threshold value smaller than the first threshold value after the preset condition is satisfied as the magnitude of the lateral gradient of the road surface becomes greater than the first threshold value.

The controller may be configured to determine a blind spot region in the surround view image based on the gradient of the road surface and control the display unit to display a visual indicator indicating the blind spot region on the surround view image.

The preset condition may include a first preset condition related to the longitudinal gradient of the road surface and a second preset condition related to the lateral gradient of the road surface. The controller may be configured to control the display unit to display a first region of the surround view image based on the first preset condition being satisfied and to control the display unit to display a second region of the surround view image based on the second preset condition being satisfied.

The controller may be configured to control the display unit to display the surround view image based on the preset condition being satisfied only when an automatic display function is activated.

The controller may be configured to control the display unit to display the surround view image based on the preset condition being satisfied only when a transmission gear is positioned at a drive (D) stage and a vehicle speed is equal to or less than a preset speed.

The controller may be configured to control the display unit to stop outputting the surround view image based on reception of a user input to interrupt the output of the surround view image.

In accordance with another aspect of the present disclosure, a control method of a vehicle includes estimating a gradient of a road surface based on a sensor value received from at least one sensor provided in the vehicle. The control method also includes displaying at least a part of a surround view image based on a preset condition related to the gradient of the road surface being satisfied.

Estimating of the gradient of the road surface may include estimating a longitudinal gradient of the road surface in real time. The control method may further include determining that an uphill condition is satisfied based on determining that the longitudinal gradient of the road surface is greater than a first threshold value. The control method may also include determining a maximum value of the longitudinal gradient in response to determining that the uphill condition is satisfied. The control method may further include determining that the preset condition is satisfied based on determining that a difference value between the maximum value of the longitudinal gradient and the longitudinal gradient of the road surface estimated in real time is greater than a second threshold.

The control method may further include stopping outputting the surround view image based on determining that the longitudinal gradient of the road surface estimated in real time has reached a third threshold value less than the first threshold value after the uphill condition is satisfied.

Estimating the gradient of the road surface may include estimating a lateral gradient of the road surface in real time. The control method may further include determining that the preset condition is satisfied based on determining that a magnitude of the lateral gradient of the road surface is greater than a first threshold value.

The control method may further include stopping outputting the surround view image based on determining that the magnitude of the lateral gradient of the road surface estimated in real time has reached a second threshold value smaller than the first threshold value after the preset condition is satisfied as the magnitude of the lateral gradient of the road surface becomes greater than the first threshold value.

The control method may further include determining a blind spot region in the surround view image based on the gradient of the road surface and displaying a visual indicator indicating the blind spot region on the surround view image.

The preset condition may include a first preset condition related to the longitudinal gradient of the road surface and a second preset condition related to the lateral gradient of the road surface. Displaying the at least the part of the surround view image may include displaying a first region of the surround view image based on the first preset condition being satisfied and displaying a second region of the surround view image based on the second preset condition being satisfied.

Displaying the at least the part of the surround view image based on the preset condition related to the gradient of the road surface being satisfied may be performed only when an automatic display function is activated.

Displaying the at least the part of the surround view image based on the preset condition related to the gradient of the road surface being satisfied may be performed only when a transmission gear is position at a drive (D) stage and a vehicle speed is equal to or less than a preset speed.

The control method may further include stopping outputting the surround view image based on reception of a user input to interrupt the output of the surround view image.

### BRIEF DESCRIPTION OF THE DRAWINGS

These and/or other aspects of the present disclosure should be more apparent and more readily appreciated from the following description taken in conjunction with the accompanying drawings, in which:

FIG. 1 schematically illustrates an exterior of a vehicle according to an embodiment;

FIG. 2 schematically illustrates an interior of the vehicle according to an embodiment;

FIG. 3 is a control block diagram of the vehicle according to an embodiment;

FIG. 4 is a flowchart of a control method of the vehicle according to an embodiment;

FIG. 5 illustrates an example of the control method of the vehicle according to an embodiment;

FIG. 6 is a graph for explaining a threshold value related to a longitudinal gradient according to an embodiment;

FIG. 7 illustrates another example of the control method of the vehicle according to another embodiment;

FIG. 8 is a graph for explaining a threshold value related to a lateral gradient according to an embodiment;

FIG. 9 is a diagram for describing a surround view image according to an embodiment;

FIG. 10 illustrates an example of the surround view image displayed on a display device when a preset condition related to the longitudinal gradient is satisfied according to an embodiment; and

FIG. 11 illustrates an example of the surround view image displayed on a display device when a preset condition related to the lateral gradient is satisfied according to an embodiment.

### DETAILED DESCRIPTION

Throughout the specification, like reference numerals refer to like elements. This specification does not describe all factors or details of embodiments, and duplicative contents between general contents or embodiments in the technical field of the present disclosure have been omitted.

Throughout the specification, when a part is referred to as being “connected” to another part, it includes not only a direct connection but also an indirect connection, and the indirect connection includes connecting through a wireless network.

When it is described that a part “includes” an element, it means that the element may further include other elements, and not exclude any other elements unless specifically stated otherwise.

The singular forms “a,” “an, ” and “the” include plural referents unless the context clearly dictates otherwise.

In addition, terms such as “˜unit”, “˜part,” “˜block,” “˜member,” “˜module,” and the like may denote a unit for performing at least one function or operation. For example, the terms may refer to at least one hardware component such as a field-programmable gate array (FPGA) or an application specific integrated circuit (ASIC), at least one software stored in a memory, or at least one process performed by a processor.

In each step or operation, an identification numeral is used for convenience of explanation. The identification numeral does not describe the order of the steps or operations. Each step or operation may be performed differently from the order specified unless the context clearly states a particular order.

When a component, device, element, or the like of the present disclosure is described as having a purpose or performing an operation, function, or the like, the component, device, or element should be considered herein as being “configured to” meet that purpose or perform that operation or function.

Hereinafter, a vehicle and a control method thereof according to embodiments of the present disclosure are described in detail with reference to the accompanying drawings.

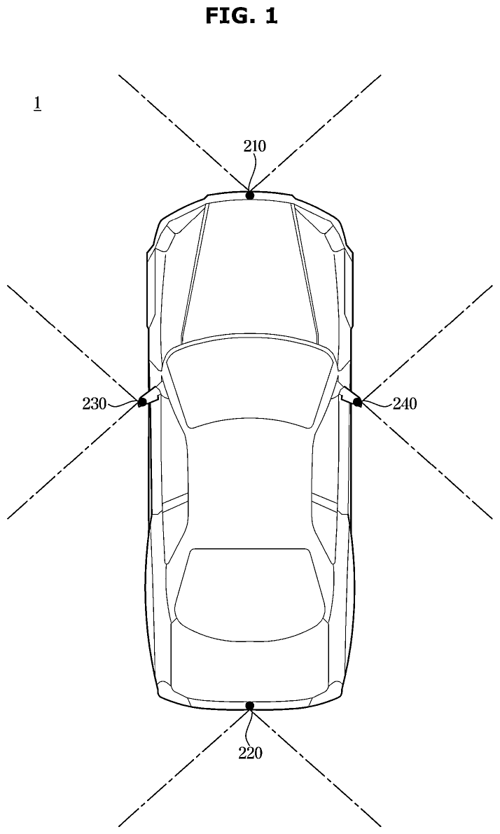

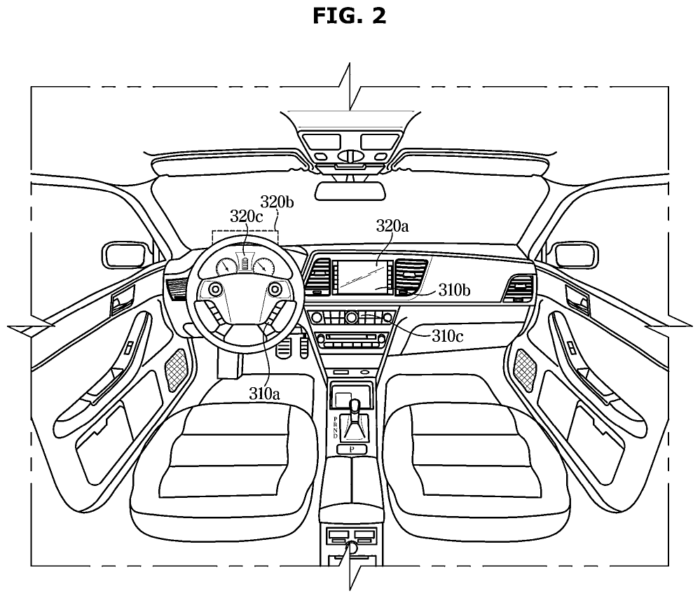

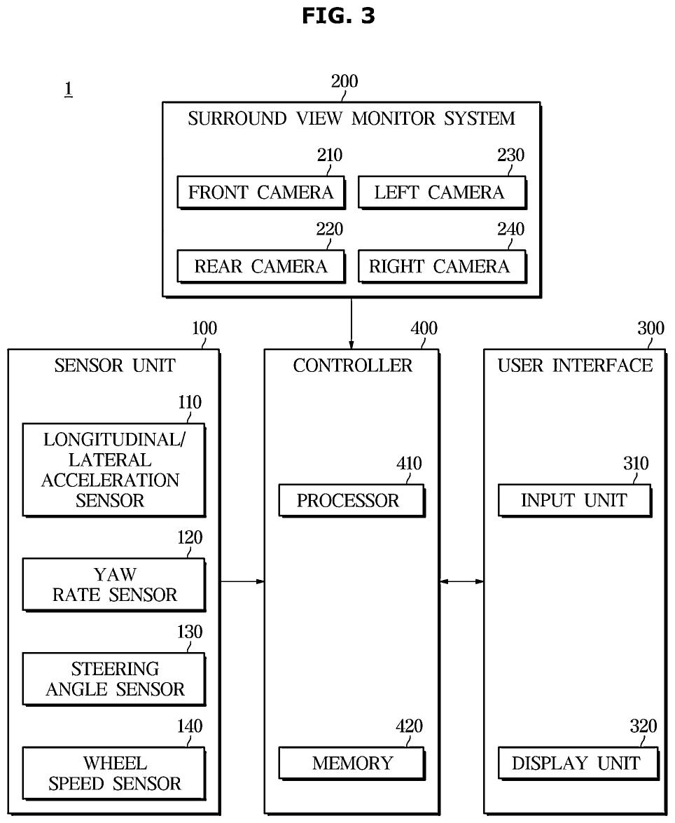

FIG. 1 schematically illustrates an exterior of a vehicle according to an embodiment. FIG. 2 schematically illustrates an interior of the vehicle according to an embodiment. FIG. 3 is a control block diagram of the vehicle according to an embodiment.

Referring to FIGS. 1-3, a vehicle 1 according to an embodiment may include a sensor unit 100, a surround view monitor system (SVM), a user interface 300, and a controller 400.

The sensor unit 100 may detect various sensor values required to calculate a gradient of a road surface on which the vehicle 1 is traveling.

According to various embodiments, the sensor unit 100 may include a longitudinal lateral acceleration sensor 110, a yaw rate sensor 120, a steering angle sensor 130, and/or a wheel speed sensor 140.

The longitudinal/lateral acceleration sensor 110 may include at least one sensor capable of measuring longitudinal acceleration and lateral acceleration of the vehicle 1.

For example, the longitudinal/lateral acceleration sensor 110 may include a longitudinal speed sensor and/or a longitudinal acceleration sensor for measuring a longitudinal speed and/or longitudinal acceleration of the vehicle 1. The longitudinal/lateral acceleration sensor 110 may also include a lateral speed sensor and/or a lateral acceleration sensor for measuring a lateral speed and/or lateral acceleration of the vehicle 1.

The longitudinal/lateral acceleration sensor 110 may obtain sensor values for a magnitude and direction of the longitudinal acceleration of the vehicle 1 and a magnitude and direction of the lateral acceleration of the vehicle 1.

The yaw rate sensor 120 may include at least one sensor for measuring a yaw rate of the vehicle 1.

The yaw rate sensor 120 may obtain a sensor value for the yaw rate of the vehicle 1.

The steering angle sensor 130 may measure a steering angle of a steering wheel of the vehicle 1.

For example, the steering angle sensor 130 may include a steering angle sensor for measuring a steering angle of the vehicle 1 depending on steering of the steering wheel and/or a steering angular velocity sensor for measuring a steering speed.

The steering angle sensor 130 may obtain a sensor value for the steering angle of the vehicle 1.

The wheel speed sensor 140 may be provided on a wheel of the vehicle 1 to measure a wheel speed. Accordingly, the wheel speed sensor 140 may measure the vehicle speed,

The wheel speed sensor 140 may obtain a sensor value for the speed of the vehicle 1.

The sensors 110, 120, 130, and 140 included in the sensor unit 100 may be implemented through known techniques. For example, the sensors 110, 120, 130, and 140 may measure a parameter by generating an electrical signal that changes in response to a change in the corresponding parameter being measured.

The sensor unit 100 may transmit a sensor value detected through at least one of the sensors 110, 120, 130, and 140 to the controller 400.

The surround view monitor system 200 may include a plurality of cameras capable of obtaining images around the vehicle 1.

For example, the surround view monitor system 200 may include a front camera 210 having a photographing area in front of the vehicle 1 to obtain a front image. The surround view monitor system 200 may also include a rear camera 220 having a photographing area at the rear of the vehicle 1 to obtain a rear image. The surround view monitor system 200 may additionally include a left camera 230 having a photographing area on the left side of the vehicle 1 to obtain a left side image and a right camera 240 having a photographing area on the right side of the vehicle 1 to obtain a right side image.

The front camera 210 may be provided without limitation at a position capable of providing the front photographing area. For example, the front camera 210 may be provided on a front grill of the vehicle 1, but the position of the front camera 210 is not limited thereto.

The rear camera 220 may be provided without limitation at a position capable of providing the rear photographing area. For example, the rear camera 220 may be provided on a trunk of the vehicle 1, but the position of the rear camera 220 is not limited thereto.

The left camera 230 and the right camera 240 may be provided at positions capable of providing, respectively, the left side photographing area and the right side photographing area, without limitation. For example, the left camera 230 may be provided on a left rear mirror and the right camera 240 may be provided on a right rear mirror, but the positions of the left camera 230 and the right camera 240 are not limited thereto.

The surround view monitor system 200 may generate a surround view image based on processing of the front image, the rear image, the left side image, and the right side image obtained from the plurality of cameras 210, 220, 230, and 240.

The surround view image, which is an image that is seen as if looking down at a vehicle from the sky, may be referred to as a top view image, an around view image, an area view image, or a bird's eye view image.

The surround view monitor system 200 may include an image processor for image processing.

The surround view image may be generated by a known method.

According to various embodiments, the surround view image may be divided into a plurality of regions. According to an embodiment, the surround view image may include the front image obtained from the front camera 210, the rear image obtained from the rear camera 220, the left side image obtained from the left camera 230, and the right side image obtained from the right camera 240.

The controller 400 may receive the surround view image from the surround view monitor system 200.

The user interface 300 may include an input unit 310 provided to receive various user inputs related to a surround view image and/or a surround view image automatic display function. The user interface 300 may also include a display unit 320 provided to display a variety of information related to the surround view image and/or the surround view image automatic display function.

The input unit 310 may include various input devices provided in the vehicle 1.

For example, the input unit 310 may include an operation button 310a provided on the steering wheel, a touch screen 310b provided on an AVN device, and/or an operation button 310c provided on a center fascia, but types of the input devices included in the input unit 310 are not limited thereto.

Any type of an input device (e.g., a dial, etc.) for receiving an input through a manipulation of a user may be employed as a component of the input unit 310.

The display unit 320 may include various display devices provided in the vehicle 1.

For example, the display unit 320 may include a display 320a provided on the AVN device and/or a head-up display 320b and/or a display 320c provided on a cluster, but the type of the display unit 320 is not limited thereto.

The display unit 320 may comprise a light emitting diode (LED) panel, an organic light emitting diode (OLED) panel, a liquid crystal display panel, and/or an indicator.

The display unit 320 may display the surround view image generated by the surround view monitor system 200 based on a control signal of the controller 400.

According to various embodiments, the display unit 320 may display the surround view image according to a plurality of modes under the control of the controller 400.

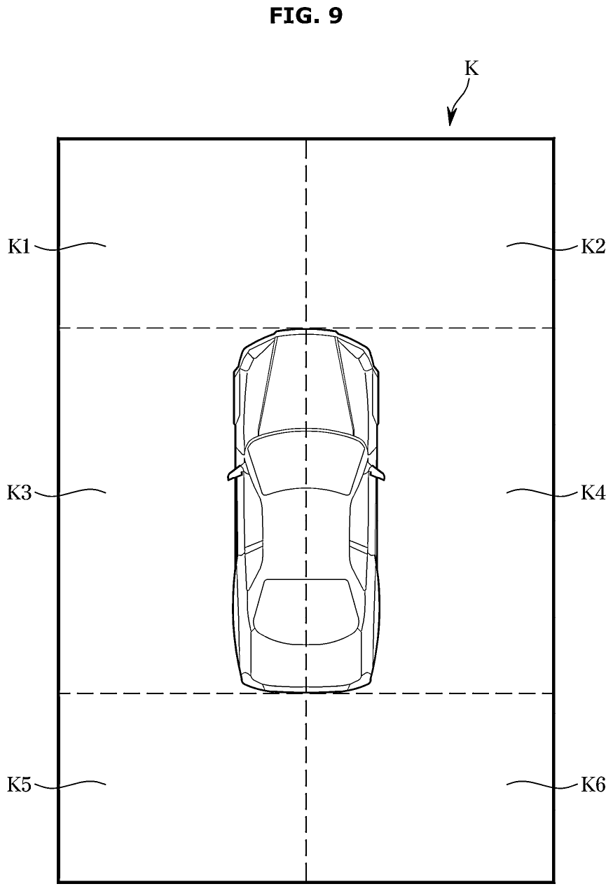

The plurality of modes may include various modes such as a front display mode and a rear display mode. The plurality of modes, according to an embodiment, are described below with reference to FIG. 9.

The controller 400 may include at least one memory 420 in which a program and/or information for performing the above-described operations and operations described below is stored. The controller 400 may also include at least one processor 410 for executing the stored program. When the controller 400 includes a plurality of memories 420 and a plurality of processors 410, the plurality of memories 420 and the plurality of processors 410 may be integrated on one chip or may be physically separated.

According to various embodiments, the controller 400 may include the at least one processor 410 mounted on a head unit, an audio, video, navigation and telematics (AUNT) terminal unit, etc., of the vehicle 1, but the present disclosure is not limited thereto. In an embodiment, the controller 400 may include a processor of a separate system (e.g., a road surface gradient estimation system) provided inside the vehicle 1.

The controller 400 may estimate the gradient of a road surface based on a sensor value received from the sensor unit 100.

The memory 420 may store various parameters (e.g., vehicle specification information, etc.) and various algorithms for estimating the gradient of the road surface based on the sensor value received from the sensor unit 100.

The controller 400 may estimate the gradient of a road surface on which the vehicle 1 is traveling based on a sensor value received from the longitudinal/lateral acceleration sensor 110, a sensor value received from the yaw rate sensor 120, a sensor value received from the steering angle sensor 130, and/or a sensor value received from the wheel speed sensor 140.

An algorithm for estimating the gradient of a road surface based on sensor values received from the sensor unit 100 may be implemented through a known technique.

The gradient of a road surface may include a longitudinal gradient and a lateral gradient of the road surface.

According to various embodiments, the display unit 320 may display information on the gradient of a road surface in real time.

The information on the gradient of the road surface may include a gradient value of the road surface (e.g., a longitudinal gradient value and a lateral gradient value). The unit of the gradient value of a road surface may be percent (%) or degree (°).

In order to prevent the gradient value of a road surface from fluctuating due to various factors, the controller 400 may process gradient value data of the road surface estimated in real time.

In an embodiment, the controller 400 may determine the gradient value of a road surface at a period of a second preset time (e.g., 100 ms) longer than a first preset time by downsampling the gradient value of the road surface estimated at a period of the first preset time (e.g., 10 ms).

In an example, when there is no change in the sign of the gradient values during samplings of ten times, the controller 400 may determine a gradient value of a road surface based on a minimum value among the gradient values of the ten samples.

In another example, when there is a change in the sign of the gradient values during samplings of ten times, the controller 400 may determine the gradient value of a road surface based on a minimum value of a sample after the last sign change among the ten samples.

When estimating the gradient value of a road surface based on the minimum value of the sample, the controller 400 may employ only an integer part of the minimum value and round a fractional part down.

In an embodiment, when the speed of the vehicle 1 is greater than a preset speed (e.g., 1 kph), the controller 400 may estimate a changed gradient value as the gradient value of a road surface in response to determining that the gradient value has increased by more than a first threshold value (e.g., 2% or 2°). The controller 400 may also estimate the changed gradient value as the gradient value of the road surface in response to determining that the gradient value has decreased by more than a second threshold value (e.g., 1% or 1°).

In an embodiment, when the speed of the vehicle 1 is less than or equal to the preset speed (e.g., 1 kph), the controller 400 may estimate the changed gradient value as the gradient value of a road surface in response to determining that the gradient value has changed by more than the threshold value (e.g., 2% or 2°).

According to embodiments of the present disclosure, by minimizing an amount of change in information displayed on the display unit 320, visual fatigue of a driver may be reduced.

In an embodiment, the controller 400 may estimate the gradient of a road surface in real time based on one or more sensor values received from the sensor unit 100 and may control the display unit 320 to automatically display a surround view image, without a manipulation by the user, based on the estimated gradient of the road surface.

In the present disclosure, a function of automatically displaying a surround view image depending on a gradient of a road surface without a manipulation by the user is defined as an automatic display function.

According to various embodiments, the user may turn on/off the automatic display function through the user interface 300.

The components illustrated in FIGS. 1-3 may transmit information to each other by performing controller area network (CAN) communication with each other and/or may transmit information to each other by performing wired communication, For example, for control of various electronic components mounted on the vehicle 1 and communication between the electronic components, a communication network including a body network, a multimedia network, a chassis network, and the like may be provided in the vehicle 1. Such communication networks may be separated from each other and may be connected by the controller 400 in order to exchange CAN communication messages with each other.

Although various components of the vehicle 1 have been described above, other components may be added or any one of the described components may be omitted within the scope of a conventional technology.

The controller 400 may receive transmission gear position information from an electronic control unit (ECU) of the vehicle 1. Accordingly, the controller 400 may determine at which position a transmission gear is among stages park (P), reverse (R), neutral (N), and drive (D).

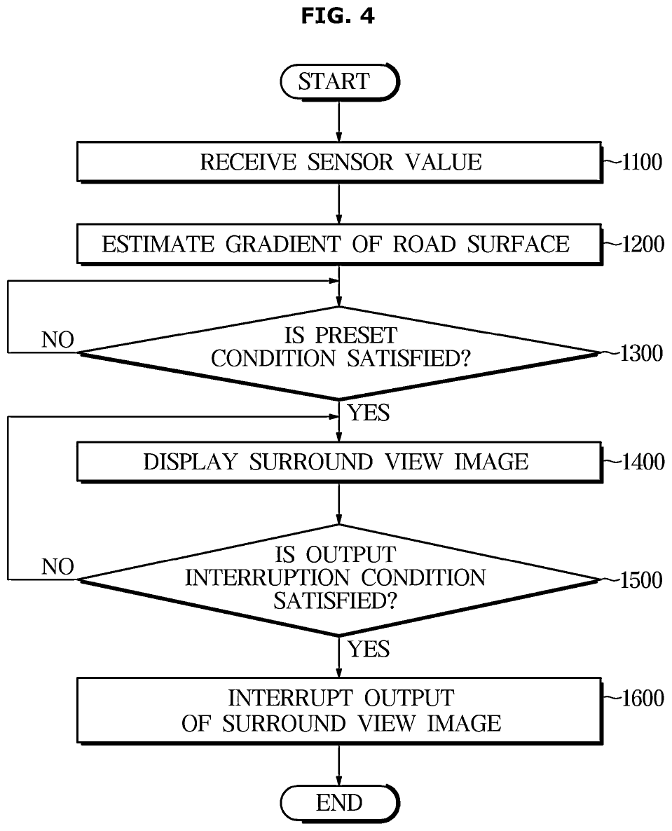

FIG. 4 is a flowchart of a control method performed by the controller 400 of the vehicle 1, according to an embodiment.

Referring to FIG. 4, in operation 1100, the controller 400 may receive a sensor value from at least one the sensors 110, 120, 130, and 140 included in the sensor unit 100.

In operation 1200, the controller 400 may estimate a gradient of a road surface based on the sensor value received from at least one of the sensors 110, 120, 130, and 140. Estimating the gradient of the road surface may include estimating a lateral gradient value of the road surface and/or estimating a longitudinal gradient value of the road surface.

In an example, the controller 400 may estimate a lateral gradient of the road surface in real time based on the sensor value and estimate a longitudinal gradient of the road surface in real time based on the sensor value.

Hereinafter, the longitudinal gradient value of a road surface estimated in real time by the controller 400 is defined as θᵣ, and the lateral gradient value of the road surface estimated in real time by the controller 400 is defined as ϕᵣ.

The unit of θᵣ may be percent (%) and the unit of ϕᵣ may be degree (°), but the unit of each value is not limited thereto.

In present specification, for convenience of explanation, when the sign of θᵣ is positive (+), it signifies that the vehicle 1 is on an uphill slope, and when the sign of θᵣ is negative (−), it signifies that the vehicle 1 is on a downhill slope.

In addition, in the present specification, for convenience of explanation, when the sign of θᵣ is positive (+), it signifies that the left side of the vehicle 1 is on a high slope, and when the sign of θᵣ is negative (−), it signifies that the right side of the vehicle 1 is on a high slope.

In operation 1300, the controller 400 may determine whether a preset condition related to the gradient of the road surface is satisfied based on the gradient of the road surface estimated in real time.

The preset condition is described in detail below.

In operation 1400, the controller 400 may control the display unit 320 to display at least a part of a surround view image when the preset condition related to the gradient of the road surface is satisfied (YES in operation 1300).

Displaying the at least the part of the surround view image may include displaying a partial region of the surround view image, displaying the surround view image in a front display mode, and the like.

According to various embodiments, the controller 400 may determine a blind spot region in the surround view image based on the gradient of the road surface.

In an example, the memory 420 may store a lookup table in which the longitudinal gradient value and/or the lateral gradient value of a road surface and a blind spot region are mapped.

The controller 400 may determine an area of the blind spot region extending to the front and a front lateral side of the vehicle 1 to be larger as the longitudinal gradient value of the road surface increases.

Also, the controller 400 may determine the area of the blind spot region extending to a lateral side of the vehicle 1 to be larger as the lateral gradient value of the road surface increases.

In operation 1600, while at least a part of the surround view image is displayed on the display unit 320 when the preset condition related to the gradient of a road surface is satisfied, the controller 400 may control the display unit 320 to stop outputting the surround view image when an output interruption condition is satisfied (YES in operation 1500).

Based on the interruption of the output of the surround view image, the display unit 320 may re-display a screen that was being displayed before the surround view image.

The output interruption condition is described in detail below.

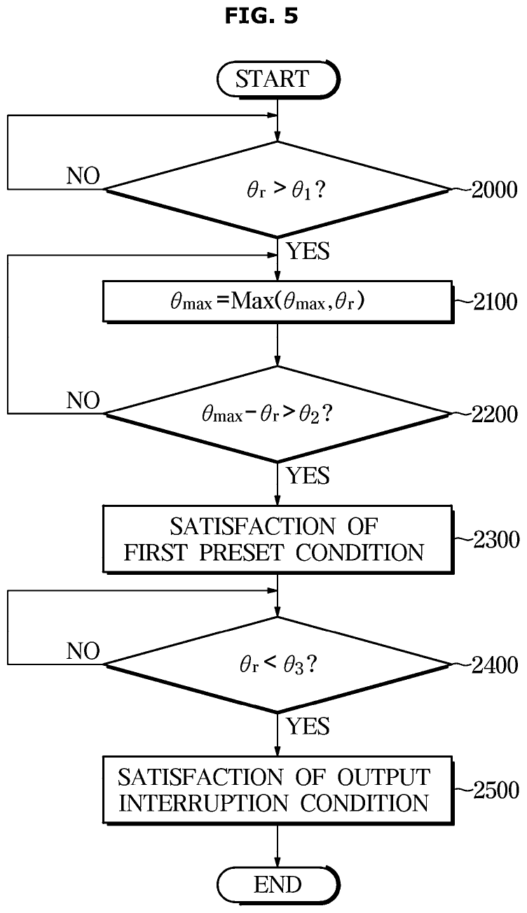

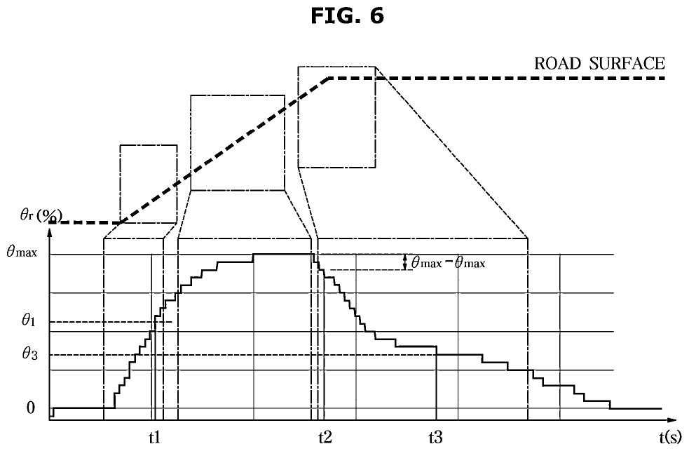

FIG. 5 illustrates an example control method performed by the controller 400 of the vehicle 1 according to an embodiment. FIG. 6 is a graph for explaining a threshold value related to a longitudinal gradient according to an embodiment.

Referring to FIGS. 5 and 6, in operation 2000, the controller 400 may determine whether the longitudinal gradient θᵣ of a road surface estimated in real time exceeds a first threshold value θ₁.

The controller 400 may determine that an uphill condition is satisfied based on determining that the longitudinal gradient θᵣ of the road surface is greater than the first threshold value θ₁.

In other words, a state in which the uphill condition is satisfied refers to a state in which the longitudinal gradient θᵣ of the road surface is greater than the first threshold value θ₁.

As a more specific example, in a state where front wheels of the vehicle 1 reach an uphill slope and rear wheels of the vehicle 1 do not reach the uphill slope, the longitudinal gradient θᵣ of the road surface may reach the first threshold value θ₁.

In FIG. 6, the longitudinal gradient θᵣ of the road surface reaches the first threshold value θ₁at a first time point t1.

When the uphill condition is satisfied, the controller 400 maintains a state in which the uphill condition is satisfied until the longitudinal gradient θᵣ of the road surface reaches a third threshold value θ₃ that is less than the first threshold θ₁.

More specifically, after the first time point t1, the uphill condition is satisfied until the longitudinal gradient θᵣ of the road surface reaches the third threshold value θ₃ that is less than the first threshold value θ₁.

In operation 2100, the controller 400 may update a maximum value θₘₐₓ of the longitudinal gradient in real time when the uphill condition is satisfied (YES in operation 2000).

Specifically, in the state where the uphill condition is satisfied, the maximum value θₘₐₓ of the longitudinal gradient may be calculated by Equation 1.

θₘₐₓ=max{θᵣ, θₘₐₓ} Equation 1

Accordingly, the controller 400 may determine the maximum value θₘₐₓ of the longitudinal gradient in the state where the uphill condition is satisfied.

In other words, the maximum value θₘₐₓ of the longitudinal gradient may continuously increase as the longitudinal gradient of the road surface increases.

When both the front and rear wheels of the vehicle 1 are positioned on the uphill slope, a change amount of the maximum value θₘₐₓ of the longitudinal gradient may become insignificant.

In operation 2200, after the uphill condition is satisfied, the controller 400 may calculate a difference value (θₘₐₓ−θᵣ) between the maximum value θₘₐₓ of the longitudinal gradient and the longitudinal gradient θᵣ of the road surface estimated in real time and may determine whether the difference value (θₘₐₓ−θᵣ) exceeds a second threshold value θ₂.

A state in which the difference value (θₘₐₓ−θᵣ) exceeds the second threshold value θ₂ may refer to a state in which the uphill slope ends.

As a more specific example, the difference value (θₘₐₓ−θᵣ) may reach the second threshold value θ₂ in a state where the front wheels of the vehicle 1 reach a flat ground and the rear wheels of the vehicle 1 are on the uphill slope.

In FIG. 6, the difference value (θₘₐₓ−θᵣ) reaches the second threshold value θ₂ at a second time point t2.

In operation 2300, the controller 400 may determine that a first preset condition is satisfied based on determining that the difference value (θₘₐₓ−θᵣ) is greater than the second threshold value θ₂ (YES in operation 2200).

The first preset condition in operation 2300 of FIG. 5 is an example of the preset condition in operation 1300 of FIG. 4.

Accordingly, the controller 400 may control the display unit 320 to display at least a part of the surround view image based on determining that the first preset condition is satisfied.

the surround view image may thus be automatically output on the display unit 320 beginning from the second time point t2.

According to an embodiment of the present disclosure, the surround view image may be automatically displayed on the display unit 320 in a situation in which a blind spot occurs in a field of view of the driver due to an uphill slope, thereby helping to secure the field of view of the driver.

While controlling the display unit 320 to display at least a part of the surround view image when the first preset condition is satisfied, the controller 400 may determine whether an output interruption condition is satisfied.

As an example, in operation 2400, the controller 400 may determine whether a magnitude of the longitudinal gradient θᵣ of the road surface estimated in real time after the uphill condition is satisfied reaches the third threshold value θ₃ that is less than the first threshold value θ₁.

In a state in which the front wheels of the vehicle 1 reach a flat ground and the rear wheels of the vehicle 1 also reach the flat ground from the uphill slope, the longitudinal gradient θᵣ of the road surface may reach the third threshold value θ₃. In other words, when the vehicle 1 finishes driving on the uphill slope and arrives on the flat ground (or downhill), the longitudinal gradient θᵣ of the road surface may reach the third threshold value θ₃.

In operation 2500, the controller 400 may determine that the output interruption condition is satisfied based on the magnitude of the longitudinal gradient θᵣ of the road surface estimated in real time that has reached the third threshold θ₃.

The output interruption condition in operation 2500 of FIG. 5 is an example of the output interruption condition in operation 1500 of FIG. 4.

Accordingly, the controller 400 may control the display unit 320 to interrupt the output of the surround view image based on determining that the output interruption condition is satisfied.

In an example, the output of the surround view image by the display unit 320 may be interrupted from a third time point t3, and a screen that was being displayed before the surround view image may be provided on the display unit 320.

Information on the first threshold value 81, the second threshold value θ₂, and the third threshold value θ₃ may be previously stored in the memory 420. In an embodiment, it is beneficial that the first threshold value θ₁ is greater than the third threshold value θ₃.

According to various embodiments, the user may adjust the first threshold value θ₁, the second threshold value θ₂, and/or the third threshold value θ₃ through the user interface 300. In other words, the controller 400 may change the first threshold value θ₁, the second threshold value θ₂, and/or the third threshold value θ₃ based on the user input.

According to embodiments of the present disclosure, because the surround view image is automatically displayed in a section in which the vehicle 1 enters from an uphill slope to a flat ground or a downhill slope, a blind spot may be effectively prevented from occurring in the field of view of the driver.

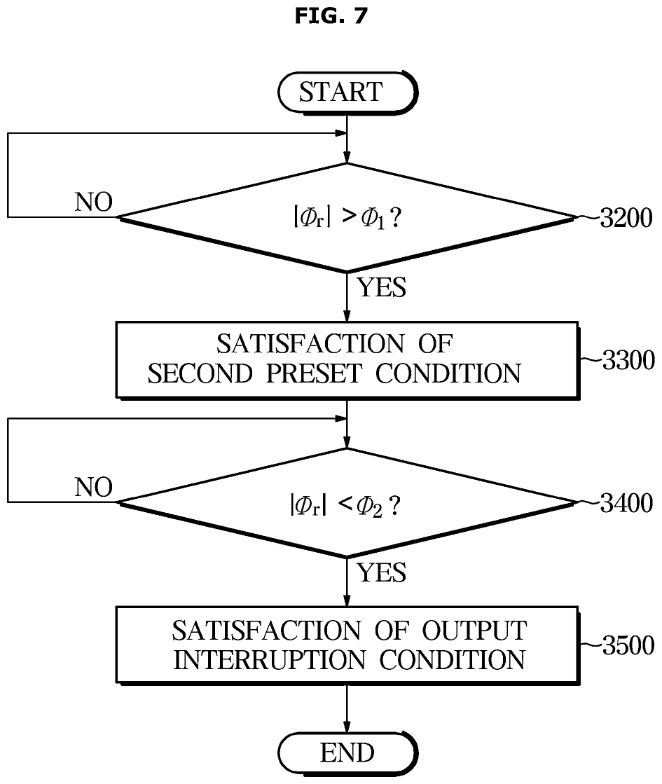

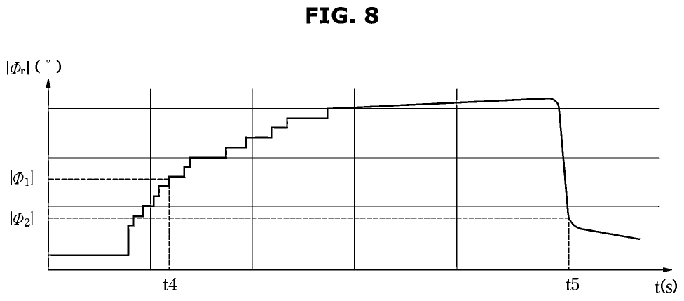

FIG. 7 illustrates another example control method performed by the controller 400 of the vehicle 1 according to an embodiment. FIG. 8 is a graph for explaining a threshold value related to a lateral gradient, according to an embodiment.

The condition related to the gradient of a road surface may include a second preset condition related to a lateral gradient of the road surface.

Referring to FIGS. 7 and 8, in operation 3200, the controller 400 may determine whether a magnitude of the lateral gradient ϕᵣ of the road surface estimated ire real time exceeds a first threshold value ϕ₁.

A blind spot occurs in an uphill section in which the longitudinal gradient has a positive value, and no blind spot occurs in a downhill section in which the longitudinal gradient has a negative value.

On the other hand, in the case of the lateral gradient, a blind spot may occur in both a situation in which a left part of the vehicle 1 is higher than a right part thereof and a situation in which the right part of the vehicle 1 is higher than the left part thereof.

Accordingly, a state in which the magnitude of the lateral gradient ϕᵣ of the road surface exceeds the first threshold value ϕ₁ refers to a state in which the left part of the vehicle 1 is higher than the right part thereof by a threshold degree or more, or a state in which the right part of the vehicle 1 is higher than the left part thereof by the threshold degree or more.

In operation 3300, the controller 400 may determine that the second preset condition is satisfied based on determining that the magnitude of the lateral gradient of the road surface estimated in real time is greater than the first threshold value ϕ1 (YES in operation 3200).

The second preset condition in operation 3300 of FIG. 7 is an example of the preset condition in operation 1300 of FIG. 4.

Accordingly, the controller 400 may control the display unit 320 to display at least a part of the surround view image based on determining that the second preset condition is satisfied.

The surround view image may thus be automatically output on the display unit 320 beginning from a fourth time point t4.

According to embodiments of the present disclosure, the surround view image may be automatically displayed on the display unit 320 in a situation in which a blind spot occurs in the field of view of the driver due to a lateral slope, thereby helping to secure the field of view of the driver.

While controlling the display unit 320 to display at least a part of the surround view image when the second preset condition is satisfied, the controller 400 may determine whether an output interruption condition is satisfied.

As an example, in operation 3400, the controller 400 may determine whether the magnitude of the lateral gradient ϕᵣ of the road surface estimated in real time after the second preset condition is satisfied reaches the second threshold value ϕ₂ that is less than the first threshold value ϕ₁.

In operation 3500, the controller 400 may determine that the output interruption condition is satisfied based on determining that the magnitude of the lateral gradient ϕᵣ of the road surface estimated in real time that has reached the second threshold ϕ₂.

The output interruption condition in operation 3500 of FIG. 7 is an example of the output interruption condition in operation 1500 of FIG. 4.

Accordingly, the controller 400 may control the display unit 320 to interrupt the output of the surround view image based on determining that the output interruption condition is satisfied.

The output of the surround view image by the display unit 320 may thus be interrupted beginning from a fifth time point t5 and a screen that was being displayed before the surround view image may be provided on the display unit 320.

According to embodiments of the present disclosure, because the surround view image is automatically displayed in a section of the lateral slope, a blind spot may be effectively prevented from occurring in the field of view of the driver.

According to various conditions, a region of the surround view image to be displayed on the display unit 320 and/or a visual display to be applied to the surround view image may be changed.

According to various embodiments, the user may adjust the first threshold value ϕ₁and/or the second threshold value ϕ₂ through the user interface 300. In other words, the controller 400 may change the first threshold value ϕ₁ and/or the second threshold value ϕ₂ based on the user input.

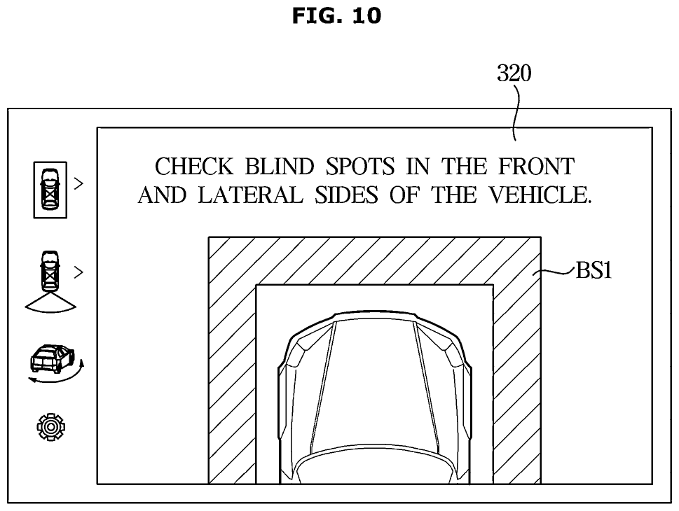

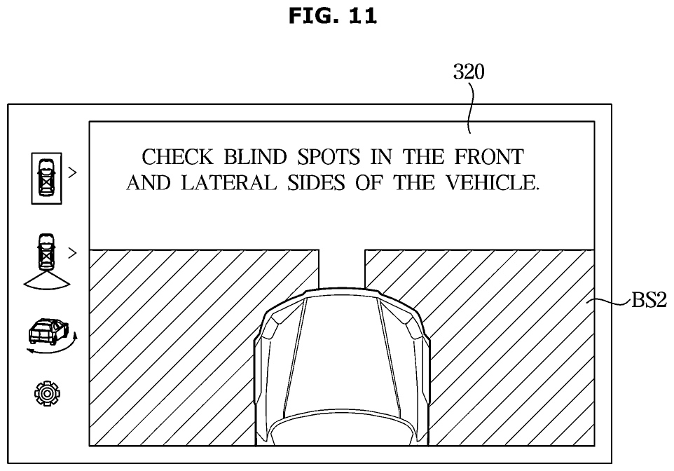

FIG. 9 is a diagram for describing a surround view image according to an embodiment. FIG. 10 illustrates an example of the surround view image displayed on a display device when a preset condition related to the longitudinal gradient is satisfied according to an embodiment. FIG. 11 illustrates an example of the surround view image displayed on a display device when a preset condition related to the lateral gradient is satisfied according to an embodiment.

Referring to FIG. 9, a surround view image K may be divided into one or more regions K1, K2, K3, K4, K5 and K6.

The front left region K1 and the front right region K2 may correspond to image parts generated based on processing of the front image obtained from the front camera 210. The left side region K3 and the right side region K4 may correspond to image parts generated based on processing of the side images obtained from the side cameras 230 and 240. The rear left side region K5 and the rear right side region K6 may correspond to image parts generated based on processing of the rear image obtained from the rear camera 220.

Depending on an image view mode, the display unit 320 may display at least a part of the surround view image K. For example, the controller 400 may control the display unit 320 to display only an upper region (portions of the regions K1, K2, and K3, and a portion of the region K4) based on a horizontal line passing through the center of the vehicle 1 in the surround view image K.

As another example, the controller 400 may control the display unit 320 to display only the parts corresponding to the front regions K1 and K2 in the surround view image K.

When controlling the display unit 320 to display only the parts corresponding to the front regions K1 and K2, the controller 400 may control the display unit 320 to directly display the front image obtained from the front camera 210.

The surround view image K according to embodiments of the present disclosure may also include the front image itself or the side image itself.

In various examples, depending on the image view mode, the surround view image K may include all kinds of images having a field of view looking at the vehicle 1 from a specific location outside the vehicle 1.

For example, in a right side display mode, the surround view image K may refer to an image having a field of view looking at the vehicle 1 from a right rear side of the vehicle 1. Accordingly, in the right side display mode, the surround view image K may include only images of the right side regions K2, K4 and K6.

As another example, in a left side display mode, the surround view image K may refer to an image having a field of view looking at the vehicle 1 from a rear left side of the vehicle 1. Accordingly, in the left side display mode, the surround view image K may include only images of the left side regions K1, K3 and K5.

As described above, the controller 400 may determine a blind spot region in the surround view image K based on the gradient of a road surface and may control the display unit 320 to display a visual indicator indicating the blind spot region on the surround view image K.

Referring to FIG. 10, the controller 400 may determine a blind spot region around the vehicle 1 based on the longitudinal gradient value of a road surface and may control the display unit 320 to display a visual indicator BS1 indicating the blind spot region on the surround view image.

As the visual indicator BS1 indicating the blind spot region, all kinds of indicators that allow the driver to identify that the corresponding region is the blind spot may be employed. For example, the visual indicator BS1 may include image effects such as color and shading.

In an example, when the surround view image is output through the display unit 320 based on the preset condition being satisfied, the controller 400 may control the display unit 320 to further display a visual indication (e.g., a phrase) for warning of an obstacle located in the blind spot.

According to various embodiments, when the first preset condition related to the longitudinal gradient of a road surface is satisfied, the controller 400 may display the front image of the vehicle 1 in parallel as well as the surround view image.

In an example, the surround view image that is output when the first preset condition related to the longitudinal gradient of a road surface is satisfied may include images of at least some regions (parts of the regions K1, K2, and K3, and a portion of the region K4).

Referring to FIG. 11, the controller 400 may determine a bond spot region around the vehicle 1 based on the lateral gradient value of a road surface and may control the display unit 320 to display a visual indicator BS2 indicating the band spot region on the surround view image.

As the visual indicator BS2 indicating the blind spot region, all kinds of indicators that allow the driver to identify that the corresponding region is the blind spot may be employed. For example, the visual indicator BS2 may include image effects such as color and shading.

In an example, when the surround view image is output through the display unit 320 based on the preset condition being satisfied, the controller 400 may control the display unit 320 to further display a visual indication (e.g., a phrase) for warning of an obstacle located in the blind spot.

According to various embodiments, when the second preset condition related to the lateral gradient of a road surface is satisfied, the controller 400 may display the side image of the vehicle 1 in parallel as well as the surround view image.

In an example, the surround view image that is output as the second preset condition related to the lateral gradient of a road surface is satisfied, may include images of at least some regions (a portion of the region K1, a portion of the region K2, and parts of the regions K3 and K4).

According to various embodiments, when the sign of the lateral gradient ϕᵣ is negative (−), i.e., when the right side of the vehicle 1 is at a high slope, the controller 400 may control the display unit 320 to display only images of the at least some regions K1, K2, K4, and K6.

On the other hand, when the sign of the lateral gradient ϕᵣ is positive (+), i.e., when the left side of the vehicle I is at a high slope, the controller 400 may control the display unit 320 to display only images of the at least some regions K1, K2, K3, and K5.

Accordingly, the controller 400 may control the display unit 320 to display a first region of the surround view image when the first preset condition related to the longitudinal gradient of a road surface is satisfied. The controller 400 may also control the display unit 320 to display a second region of the surround view image when the second preset condition related to the lateral gradient of the road surface is satisfied.

Accordingly, the surround view mage in embodiments of the present disclosure may include all images having a field of view seen as if looking at the vehicle 1 from various points of the vehicle 1.

In an embodiment, the controller 400 may determine an optimal viewpoint based on the gradient of a road surface and may control the display unit 320 to display a surround view image corresponding to the determined viewpoint.

According to embodiments of the present disclosure, when a blind spot occurs due to a change in the gradient of a road surface, a surround view image is automatically provided through the display unit 320. Thus, a collision with an obstacle in a blind spot region may be prevented in advance and convenience of the driver may be improved.

In an embodiment, the controller 400 may control the display unit 320 to display a surround view image based on the preset condition being satisfied only when the automatic display function is activated. In other words, the controller 400 may operate the automatic display function only when the user activates the function through the user interface 300, thereby satisfying need of the user.

In an embodiment, the controller 400 may control the display unit 320 to display a surround view image based on the preset condition being satisfied only when the transmission gear is positioned at the drive (D) stage and the speed of the vehicle 1 is less than or equal to a preset speed (e.g., 30 kph).

According to embodiments of the present disclosure, a surround view image may be automatically displayed only when a blind spot needs to be identified.

In addition, while the surround view image is being output based on the preset condition being satisfied, the output may need to be interrupted depending on a selection of the user.

In an embodiment, the controller 400 may control the display unit 320 to interrupt the output of the surround view image based on reception of user input to interrupt the output of the surround view image. The user input to interrupt the output of the surround view image may be received through the user interface 300.

As is apparent from the above, according to embodiments of the present disclosure, driving safety may be secured by automatically providing a surround view image in a situation where a blind spot occurs in a field of view of a driver depending on a gradient of a road surface.

Furthermore, according to embodiments of the present disclosure, the driver can easily recognize a portion corresponding to a blind spot region in the surround view image.

Furthermore, according to embodiments of the present disclosure, collision with an obstacle located in the blind spot can be prevented.

Furthermore, according to embodiments of the present disclosure, because the driver does not need to manually operate an input device to receive the surround view image, convenience of the driver can be improved.

Examples of a vehicle and a control method thereof are not limited to the above, and the embodiments described above are representative examples in all respects. Therefore, those having ordinary skill in the art to which the present disclosure pertains should be able to understand that the present disclosure may be embodied in other specific forms without changing the technical spirit or essential characteristics thereof. The scope of the present disclosure is represented in the claims rather than the foregoing description, and all differences within the scope equivalent thereto should be construed as being included within the scope of the present disclosure.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

What is claimed is:

1. A vehicle comprising:
at least one sensor;
a display;
a surround view monitor system configured to obtain a surround view image; and
a controller configured to
estimate a gradient of a road surface based on a sensor value received from the at least one sensor, and
control the display to display at least a part of the surround view image based on a preset condition related to the gradient of the road surface being satisfied.

2. The vehicle according to claim 1, wherein the controller is configured to:
estimate a longitudinal gradient of the road surface in real time;
determine that an uphill condition is satisfied based on determining that the longitudinal gradient of the road surface is greater than a first threshold value;
determine a maximum value of the longitudinal gradient in response to determining that the uphill condition is satisfied; and
determine that the preset condition is satisfied based on determining that a difference value between the maximum value of the longitudinal gradient and the longitudinal gradient of the road surface estimated in real time is greater than a second threshold.

3. The vehicle according to claim 2, wherein the controller is configured to control the display to stop outputting the surround view image based on determining that the longitudinal gradient of the road surface estimated in real time has reached a third threshold value after the uphill condition is satisfied, and wherein the third threshold value is less than the first threshold value.

4. The vehicle according to claim 1, wherein the controller is configured to:
estimate a lateral gradient of the road surface in real time; and
determine that the preset condition is satisfied based on determining that a magnitude of the lateral gradient of the road surface is greater than a first threshold value.

5. The vehicle according to claim 4, wherein the controller is configured to control the display to stop outputting the surround view image based on determining that the magnitude of the lateral gradient of the road surface estimated in real time has reached a second threshold value after the preset condition is satisfied as the magnitude of the lateral gradient of the road surface becomes greater than the first threshold value, and wherein the second threshold value is smaller than the first threshold value.

6. The vehicle according to claim 1, wherein the controller is configured to:
determine a blind spot region in the surround view image based on the gradient of the road surface; and
control the display to display a visual indicator indicating the blind spot region on the surround view image.

7. The vehicle according to claim 1, wherein:
the preset condition comprises a first preset condition related to the longitudinal gradient of the road surface and a second preset condition related to the lateral gradient of the road surface; and
the controller is configured to
control the display to display a first region of the surround view image based on the first preset condition being satisfied, and
control the display to display a second region of the surround view image based on the second preset condition being satisfied.

8. The vehicle according to claim 1, wherein the controller is configured to control the display to display the surround view image based on the preset condition being satisfied only when an automatic display function is activated.

9. The vehicle according to claim 1, wherein the controller is configured to control the display to display the surround view image based on the preset condition being satisfied only when a transmission gear is position at a drive (D) stage and a vehicle speed is equal to or less than a preset speed.

10. The vehicle according to claim 1, wherein the controller is configured to control the display to stop outputting the surround view image based on reception of a user input to interrupt the output of the surround view image.

11. A control method of a vehicle comprising:
estimating a gradient of a road surface based on a sensor value received from at least one sensor provided in the vehicle; and
displaying at least a part of a surround view image based on a preset condition related to the gradient of the road surface being satisfied.

12. The control method according to claim 11, wherein
estimating the gradient of the road surface comprises estimating a longitudinal gradient of the road surface in real time, and
the control method further comprises
determining that an uphill condition is satisfied based on determining that the longitudinal gradient of the road surface is greater than a first threshold value,
determining a maximum value of the longitudinal gradient in response to determining that the uphill condition is satisfied, and
determining that the preset condition is satisfied based on determining that a difference value between the maximum value of the longitudinal gradient and the longitudinal gradient of the road surface estimated in real time is greater than a second threshold.

13. The control method according to claim 12, further comprising:
stopping outputting the surround view image based on determining that the longitudinal gradient of the road surface estimated in real time has reached a third threshold value after the uphill condition is satisfied, wherein the third threshold value is less than the first threshold value.

14. The control method according to claim 11, wherein:
estimating the gradient of the road surface comprises estimating a lateral gradient of the road surface in real time; and
the control method further comprises determining that the preset condition is satisfied based on determining that a magnitude of the lateral gradient of the road surface is greater than a first threshold value.

15. The control method according to claim 14, further comprising:
stopping outputting the surround view image based on determining that the magnitude of the lateral gradient of the road surface estimated in real time has reached a second threshold value after the preset condition is satisfied as the magnitude of the lateral gradient of the road surface becomes greater than the first threshold value, wherein the second threshold value is smaller than the first threshold value.

16. The control method according to claim 11, further comprising:
determining a blind spot region in the surround view image based on the gradient of the road surface; and
displaying a visual indicator indicating the blind spot region on the surround view image.

17. The control method according to claim 11, wherein
the preset condition comprises a first preset condition related to the longitudinal gradient of the road surface and a second preset condition related to the lateral gradient of the road surface, and
displaying at least a part of the surround view image comprises
displaying a first region of the surround view image based the first preset condition being satisfied, and
displaying a second region of the surround view image based on the second preset condition being satisfied.

18. The control method according to claim 11, wherein displaying the at least the part of the surround view image based on the preset condition related to the gradient of the road surface being satisfied is performed only when an automatic display function is activated.

19. The control method according to claim 11, wherein displaying the at least the part of the surround view image based on the preset condition related to the gradient of the road surface being satisfied is performed only when a transmission gear is position at a drive (D) stage and a vehicle speed is equal to or less than a preset speed.

20. The control method according to claim 11, further comprising:
stopping outputting the surround view image based on reception of a user input to interrupt the output of the surround view image.
